(19) United States
(12) Patent Application Publication
(10) Pub. No.: US 2013/0127235 A1
(43) Pub. Date: May 23, 2013

(54) Wheel Bearing Apparatus For A Vehicle

(71) Applicant: NTN CORPORATION, Osaka-shi (JP)

(72) Inventors: Kazunari YAMAMOTO, Iwata-shi (JP); Nobukatsu UCHIYAMA, Iwata-shi (JP)

(73) Assignee: NTN CORPORATION, Osaka-shi (JP)

(21) Appl. No.: 13/713,259

(22) Filed: Dec. 13, 2012

Related U.S. Application Data
(63) Continuation of application No. PCT/JP2011/063513, filed on Jun. 13, 2011.

(30) Foreign Application Priority Data
Jun. 14, 2010 (JP) 2010-134856

(51) Int. Cl. B60B 27/00

(52) U.S. Cl. CPC B60B 27/0005
USPC 301/109

(57) ABSTRACT

A vehicle wheel bearing apparatus has an outer member and a constant velocity joint connected to a wheel hub. The wheel hub and the constant velocity joint outer joint member are axially detachably connected. An end face of the caulked portion has a flat surface. A cap is mounted on the caulked portion. The cap has a metal core press-formed of a corrosion resistant steel sheet with a generally ring shape having a substantially L-shaped cross-section and a molded portion. The molded portion is formed from synthetic resin and has an infinite number of micro indentations on its surface. The cap abuts against the end face of the caulked portion and the shoulder portion of the outer joint member.

### CROSS-REFERENCE TO RELATED APPLICATIONS

This application is a continuation of International Application No. PCT/JP2011/063513, filed Jun. 13, 2011, which claims priority to Japanese Application No. 2010-134856, filed Jun. 14, 2010. The disclosures of the above applications are incorporating herein by reference.

### FIELD

The present disclosure relates to a vehicle wheel bearing apparatus that supports a wheel of a vehicle, such as an automobile and, more particularly, to a wheel bearing apparatus that includes a wheel bearing and a constant velocity universal joint to rotationally support a driving wheel (front wheel of an FF vehicle, a rear wheel of an FR or RR vehicle and whole wheels of 4 WD vehicle) mounted on an independent suspension relative to the suspension apparatus.

### BACKGROUND

In a power transmitting apparatus that transmits engine power of a vehicle, such as an automobile, to its wheels, it is necessary not only to transmit the power from the engine to the wheels, but to allow radial, axial and moment displacements. Moment displacement on the wheels is caused by bounds or turns of a vehicle during running on a rough road. Accordingly, the power transmitting apparatus is connected to the driving wheel, via a wheel bearing apparatus that includes a constant velocity universal joint. One end of a drive shaft, arranged between an engine side and the driving wheel side, is connected to a differential gear unit, via a constant velocity universal joint of a sliding type and the other end includes a secured type.

It is known in such a vehicle that a large torque is transmitted to the wheels from the engine via the constant velocity universal joint of the sliding type on starting the vehicle at a low engine speed. Accordingly, torsion is created in the drive shaft. As a result of which, torsion is also created in an inner member of the wheel bearing that supports the drive shaft. Thus, a stick-slip noise is created by a sudden slip between abutting surfaces of an outer joint member of the constant velocity universal joint and the inner member when the large torsion is caused in the drive shaft.

For coping with this problem, a known wheel bearing apparatus is shown in FIG. 6. This wheel bearing apparatus includes an inner member 51, an outer member 60, double row balls 58, 58 rollably contained between the inner and outer members 51, 60. A constant velocity universal joint 63 is detachably connected to the wheel bearing. The inner member has a wheel hub 52 and an inner ring 53 press-fit onto the wheel hub 52.

The wheel hub 52 is integrally formed with a wheel mounting flange 54 on its one end for mounting a wheel (not shown). The wheel hub 52 is also formed with one inner raceway surface 52a on its outer circumference. A cylindrical portion 52b axially extends from the inner raceway surface 52a. A serration 52c is formed on its inner circumference for torque transmission. Hub bolts 55 are arranged equidistantly along the periphery of the wheel mounting flange 54.

The inner ring 53, formed on its outer circumference with the other inner raceway surface 53a, is press-fit onto the cylindrical portion 52b of the wheel hub 52. It is axially secured by a caulked portion 56. The caulked portion 56 is formed by plastically deforming the end of the cylindrical portion 52b radially outward.

The outer member 60 is integrally formed on its outer circumference with a body mounting flange 60b to be mounted on a body of a vehicle (not shown). The outer member inner circumference includes double row outer raceway surfaces 60a, 60a opposite to the inner raceway surfaces 52a, 53a of the inner member 51. Double row balls 58, 58 are contained between the outer and inner raceway surfaces 60a, 52a and 60a, 53a of the outer member 60 and the inner member 51. The double row balls 58, 58 are rollably held by cages 59, 59. Seals 61, 62 are mounted within annular openings formed between the outer member 60 and the inner member 51. The seals 61, 62 prevent leakage of grease contained in the bearing and the entry of rainwater and dust into the bearing from the outside.

The constant velocity universal joint 63 has an outer joint member 64, a joint inner ring and torque transmitting balls (not shown). The outer joint member 64 is integrally formed with a cup shaped mouth portion (not shown), a shoulder portion 65 forming a bottom of the mouth portion, and a stem portion 66 that axially extends from the shoulder portion 65. The stem portion 66 is formed, on its outer circumference, with a serration 66a that engages with the serration 52a formed on the wheel hub 52. An external thread 66b is formed on the end of the serration 66a. The stem portion 66 of the outer joint member 64 is inserted into the wheel hub 52 until the shoulder portion 65 abuts against the caulked portion 56 of the wheel hub 51, via a cap 67 hereinafter described. A securing nut 68 is fastened onto an external thread 66b, with a predetermined fastening torque, to enable the wheel hub 52 and the outer joint member 64 to be detachably connected.

The cap 67 is secured by being sandwiched between the caulked portion 56 and the shoulder portion 65 of the outer joint member 64. The cap 67 is press-formed from austenitic-stainless steel sheet with corrosion resistance. It has a surface roughness of 0.63 or less and has a substantially L-shaped cross-section.

As shown in an enlarged view of FIG. 7, the cap 67 includes a disc shaped abutting portion 67a, a cylindrical portion 67b and an anchoring portion 67c. The cylindrical portion 67b axially extends from a radially outermost portion of the abutting portion 67a. The anchoring portion 67c is bent radially inward from the end of the cylindrical portion 67b. The inner diameter of the anchoring portion 67c of the cap 17 is set slightly smaller than the outer diameter of the caulked portion 56. The cap 67 is adapted to be mounted on the caulked portion 56 by elastically deforming the anchoring portion 67c. This enables one-touch mounting of the cap 67 onto the caulked portion 56. Thus, this prevents the cap 67 from slipping off from the caulked portion 56 during the assembling step. In addition, it is possible to prevent the generation of the stick-slip noise due to a reduction of the coefficient of friction. Thus, this provides suppression of sudden slip generated between the caulked portion 56 and the shoulder portion 65 (see Japanese Laid-open Patent Publication No. 296841/2008).

However, in the prior art vehicle wheel bearing apparatus, it is believed that adhesion due to metal-to-metal contact is caused in abutting surfaces between opposite surfaces of the cap 67 and a surface of the shoulder portion 65 of the outer joint member 64 and/or a surface of the caulked portion 56. Accordingly, the stick-slip noise is caused when the adhesion is broken.

### SUMMARY

It is, therefore, an object of the present disclosure to provide a vehicle wheel bearing apparatus that can reduce the sudden slip between the inner member (particularly the caulked portion) and the shoulder portion of the outer joint member. Thus, it can prevent the generation of the stick-slip noise.

To achieve the object of the present disclosure, there is provided, a vehicle wheel bearing apparatus that comprises an outer member integrally formed on its inner circumference with double row outer raceway surfaces. An inner member includes a wheel hub and at least one inner ring. The inner member includes double row inner raceway surfaces arranged opposite to the double row outer raceway surfaces. The wheel hub is integrally formed, on its one end, with a wheel mounting flange. The other end includes an axially extending cylindrical portion. The inner ring is press fit onto the cylindrical portion of the wheel hub. Double row rolling elements are rollably contained between the double row inner and outer raceway surfaces of the inner member and the outer member via cages. Seals are mounted in annular space openings formed between the outer member and the inner member. The inner ring is axially immovably secured relative to the wheel hub by a caulked portion. The caulked portion is formed by plastically deforming an end of the cylindrical portion radially outward. A constant velocity universal joint is connected to the wheel hub. An outer joint member of the constant velocity universal joint includes a cup-shaped mouth portion, a shoulder portion and a stem portion. The shoulder portion forms a bottom of the mouth portion. The stem portion is fit into the wheel hub, via serrations, in a torque transmittable manner. The wheel hub and the outer joint member are axially detachably connected with the shoulder portion abutted against the caulked portion. The end face of the caulked portion is formed with a flat surface. A cap is mounted on the caulked portion. The cap includes a metal core press-formed from a corrosion resistant steel sheet. It has a generally ring shape with a substantially L-shaped cross-section. A molded portion is coupled with the cap. The molded potion is formed from synthetic resin and has an infinite number of micro indentations on its surface. The cap abuts against the end face of the caulked portion and the shoulder portion of the outer joint member.

The vehicle wheel bearing apparatus has the inner ring axially immovably secured relative to the wheel hub by a caulked portion. The caulked portion is formed by plastically deforming an end of the cylindrical portion of the wheel hub radially outward. A constant velocity universal joint is connected to the wheel hub. An outer joint member of the constant velocity universal joint has a cup-shaped mouth portion, a shoulder portion and a stem portion. The shoulder portion forms a bottom of the mouth portion. The stem portion is fit into the wheel hub via serrations in a torque transmittable manner. The wheel hub and the outer joint member are axially detachably connected. The shoulder portion abuts against the caulked portion. The end face of the caulked portion is formed with a flat surface. A cap is mounted on the caulked portion. The cap has a metal core press-formed from a corrosion resistant steel sheet. The cap has a generally ring shape with a substantially L-shaped cross-section and a molded portion. The molded portion is formed from synthetic resin and has an infinite number of micro indentations on its surface. The cap abuts against the end face of the caulked portion and the shoulder portion of the outer joint member. Thus, it is possible not only to suppress wear of the cap and improve its durability but also to prevent the generation of the stick-slip noise. This is accomplished by reducing a sudden slip generated between the caulked portion and the shoulder portion of the outer joint member while reducing the coefficients of friction of the abutting surfaces.

The molded portion has a surface roughness of Ra 1.6 or less. This prevents the generation of the stick-slip noise by reducing the coefficient of friction.

The surface of the metal core is formed with an infinite number of micro indentations. This further effectively prevents the generation of the stick-slip noise by reducing a sudden slip generated between the caulked portion and the shoulder portion of the outer joint member while reducing the coefficients of friction of the abutting surfaces.

The indentations of the metal core are formed by shot blasting and have a surface roughness of Ra 1.6 or less. This reduces the coefficient of friction and thus prevents the generation of the stick-slip noise.

The metal core includes a disc-shaped portion, a cylindrical portion and an anchoring portion. The cylindrical portion axially extends from a radially outermost portion of the disc-shaped portion. The anchoring portion projects radially inward from the cylindrical portion. The molded portion is adhered to the disc-shaped portion. The inner diameter of the anchoring portion of the metal core is set slightly smaller than the outer diameter of the caulked portion. This makes it possible to easily mount the cap onto the caulked portion in a snap-fit manner. Accordingly, this improves the workability during assembly.

The metal core is formed as an open ended ring shape. It has a plurality of anchoring portions formed equidistantly along the periphery of the metal core.

Lubricant is applied between the caulked portion and the shoulder portion of the outer joint member. This reduces the coefficients of friction of the abutting surfaces. Thus, this further effectively prevents the generation of the stick-slip noise as well as suppressing wear of the caulked portion and the cap.

A number of through apertures are formed on the disc-shaped portion of the metal core. This makes it possible to hold the lubricant applied to the abutting surfaces in the through apertures. Thus, this further reduces the coefficients friction of the abutting surfaces and accordingly wear.

The end face of the caulked portion and the shoulder portion of the outer joint member have a surface roughness of Ra 1.6 or less. This suppresses wear of the cap and thus improves its durability.

The end face of the caulked portion is formed with an annular groove. The disc-shaped portion of the metal core is formed with an annular projection. The annular projection axially projects from the disk shaped portion to engage with the annular groove. This makes it possible to easily achieve a radial positioning of the cap relative to the caulked portion. Also, it prevents slipping-off of the cap during transportation or assembly of the wheel bearing. Additionally, it prevents tilted mounting of the cap during assembly and thus improves the reliability of assembly.

The molded portion is formed from fiber reinforced thermoplastic synthetic resin. This reduces the coefficient of friction and accordingly the wear of the molded portion. It improves its strength and durability.

The molded portion is formed from biodegradable synthetic resin. This reduces the environmental load.

The vehicle wheel bearing apparatus comprises an outer member integrally formed, on its inner circumference, with double row outer raceway surfaces. An inner member includes a wheel hub and at least one inner ring. The inner member is formed with double row inner raceway surfaces arranged opposite to the double row outer raceway surfaces. The wheel hub is integrally formed, on its one end, with a wheel mounting flange. Its other end includes an axially extending cylindrical portion. The inner ring is press fit onto the cylindrical portion of the wheel hub. Double row rolling elements are rollably contained between the double row inner and outer raceway surfaces of the inner member and the outer member, via cages. Seals are mounted in annular space openings formed between the outer member and the inner member. The inner ring is axially immovably secured relative to the wheel hub by a caulked portion. The caulked portion is formed by plastically deforming an end of the cylindrical portion radially outward. A constant velocity universal joint is connected to the wheel hub. An outer joint member of the constant velocity universal joint has a cup-shaped mouth portion, a shoulder portion and a stem portion. The shoulder portion forms a bottom of the mouth portion. The stem portion is fit into the wheel hub, via serrations, in a torque transmittable manner. The wheel hub and the outer joint member are axially detachably connected. The shoulder portion abuts against the caulked portion. The end face of the caulked portion has a flat surface. A cap is mounted on the caulked portion. The cap has a metal core press-formed from a corrosion resistant steel sheet. The cap is generally ring shape with a substantially L-shaped cross-section and a molded portion. The molded portion is formed from synthetic resin and has an infinite number of micro indentations on its surface. The cap abuts against the end face of the caulked portion and the shoulder portion of the outer joint member. Thus, it is possible not only to suppress wear of the cap and improve its durability but also to prevent the generation of the stick-slip noise. This is accomplished by reducing a sudden slip generated between the caulked portion and the shoulder portion of the outer joint member while reducing the coefficients of friction of the abutting surfaces.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal section view of a first embodiment of a vehicle wheel bearing apparatus;

FIG. 2 is a partially enlarged view of FIG. 1;

FIG. 3(a) is a front elevation view of a cap of FIG. 2;

FIG. 3(b) is a cross-sectional view taken along a line of FIG. 3(a);

FIG. 4(a) is a front elevation view of one modification of the cap of FIG. 2;

FIG. 4(b) is a cross-sectional view taken along a line IV-IV of FIG. 4(a);

FIG. 5 is a partially enlarged view of another modification of the cap of FIG. 2;

FIG. 6 is a longitudinal section view of a prior art vehicle bearing apparatus; and

FIG. 7 is a partially enlarged view of FIG. 6.

### DETAILED DESCRIPTION

The present disclosure is a vehicle wheel bearing apparatus comprising an outer member integrally formed, on its outer circumference, with a body mounting flange. The outer member inner circumference includes double row outer raceway surfaces. An inner member includes a wheel hub and an inner ring. The wheel hub is integrally formed, on its one end, with a wheel mounting flange. The wheel hub outer circumference includes one inner raceway surface corresponding to one of the outer raceway surface. The wheel hub other end includes a cylindrical portion. The inner ring is press fit onto the cylindrical portion of the wheel hub. The inner ring includes the other inner raceway surface corresponding to the other of the double row outer raceway surfaces. Double row rolling elements are rollably contained between the double row inner and outer raceway surfaces of the inner member and the outer member via cages. Seals are mounted in annular space openings formed between the outer member and the inner member. The inner ring is axially immovably secured relative to the wheel hub by a caulked portion. The caulked portion is formed by plastically deforming an end of the cylindrical portion radially outward. A constant velocity universal joint is connected to the wheel hub. An outer joint member of the constant velocity universal joint has a cup-shaped mouth portion, a shoulder portion and a stem portion. The shoulder portion forms a bottom of the mouth portion. The stem portion fits into the wheel hub, via serrations, in a torque transmittable manner. The wheel hub and the outer joint member are axially detachably connected. The shoulder portion abuts against the caulked portion. The end face of the caulked portion has a flat surface. A cap is mounted on the caulked portion. The cap includes a metal core press-formed of a corrosion resistant steel sheet. The cap has a generally ring shape with a substantially L-shaped cross-section, and a molded portion. The molded portion is formed from synthetic resin and has an infinite number of micro indentations on its surface. The cap abuts against the end face of the caulked portion and the shoulder portion of the outer joint member.

Embodiments of the present disclosure will be described with reference to the drawings.

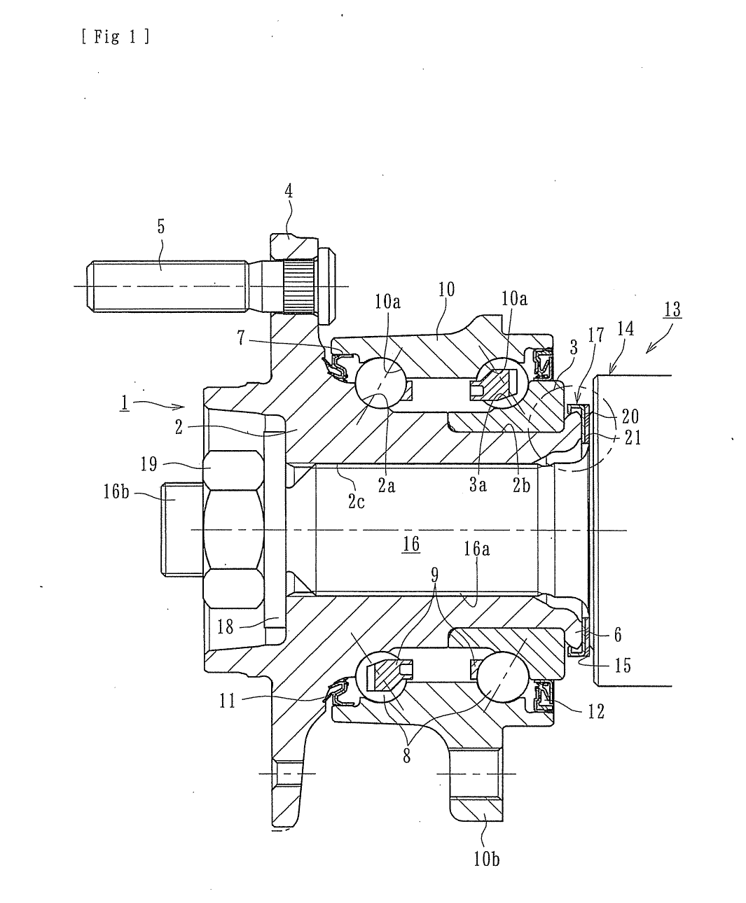

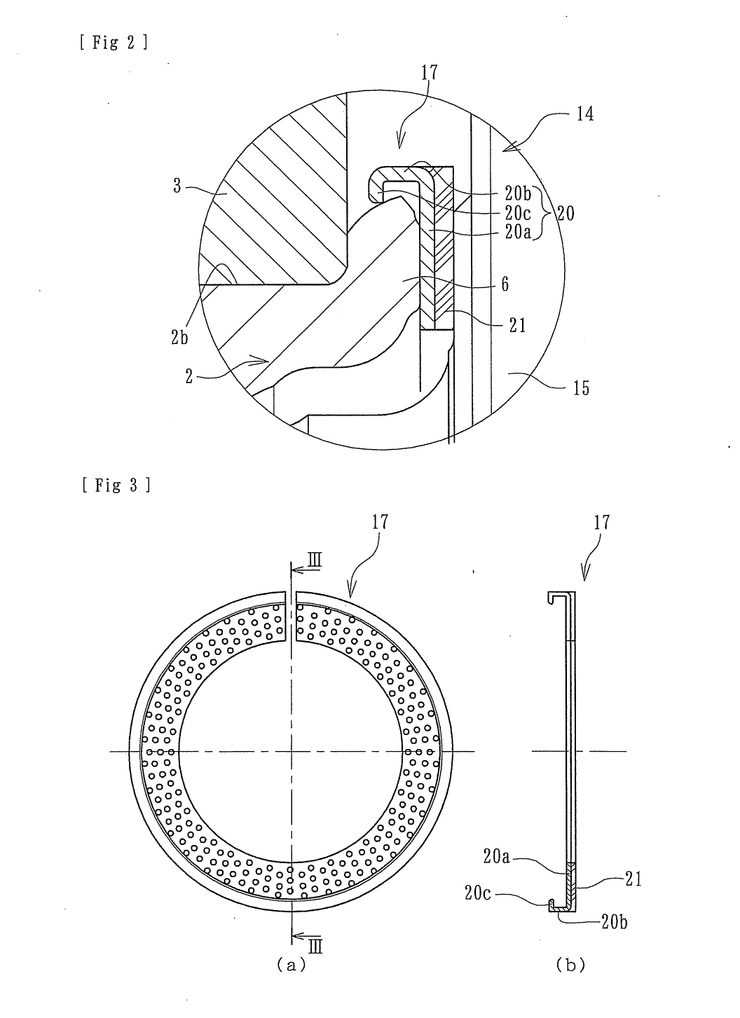

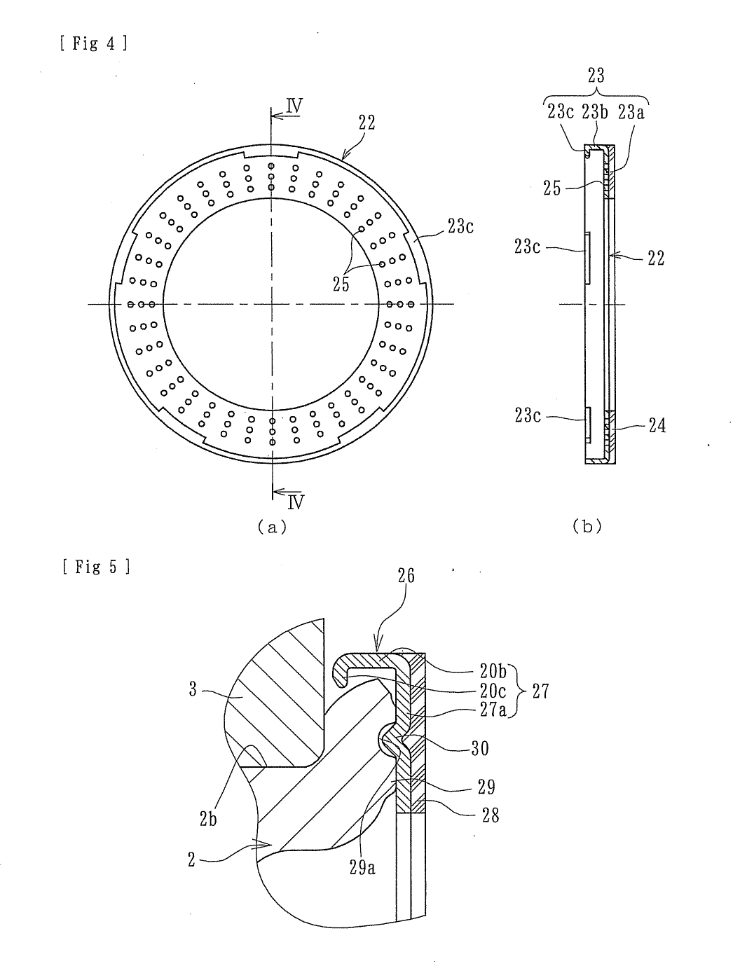

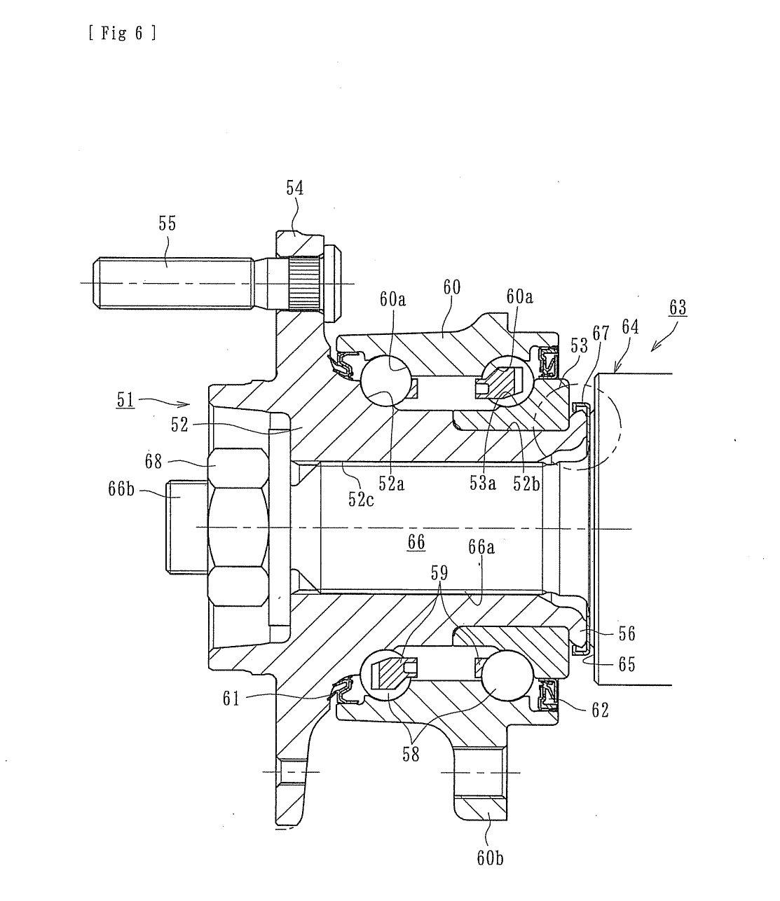

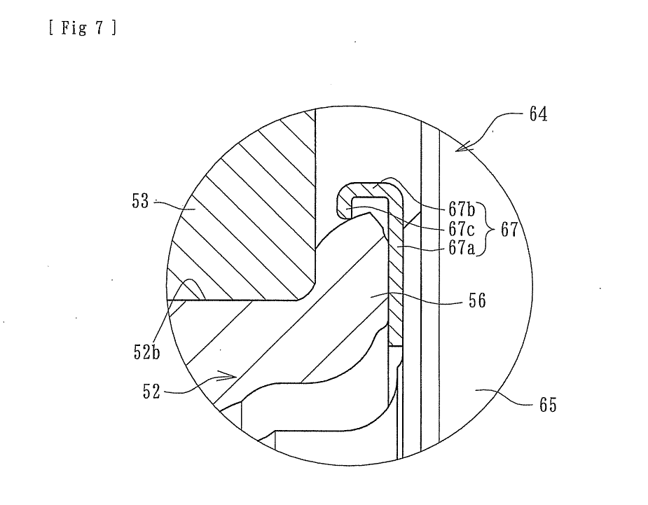

FIG. 1 is a longitudinal section view of a first embodiment of the vehicle wheel bearing apparatus. FIG. 2 is a partially enlarged view of FIG. 1. FIG. 3(a) is a front elevation view of a cap of FIG. 2. FIG. 3(b) is a cross-sectional view taken along a line III-III of FIG. 3(a). FIG. 4(a) is a front elevation view of one modification of the cap of FIG. 2. FIG. 4(b) is a cross-sectional view taken along a line IV-IV of FIG. 4(a). FIG. 5 is a partially enlarged view of another modification of the cap of FIG. 2. In the description below, the term “outer side” of the apparatus denotes a side that is positioned outside of the vehicle body (the left-side in a drawing). The term “inner side” of the apparatus denotes a side that is positioned inside of the body (the right-side in a drawing) when the bearing apparatus is mounted on the vehicle body.

The vehicle bearing apparatus of the present disclosure is a third generation type used for a driven wheel. It has an inner member 1, an outer member 10, and double row rolling elements (balls) 8, 8 rollably contained between the inner and outer members 1, 10. The inner member 1 includes a wheel hub 2 and an inner ring 3 secured on the wheel hub 2.

The wheel hub 2 is integrally formed with a wheel mounting flange 4 at its one end. One (outer side) inner raceway surface 2a is formed on its outer circumference. A cylindrical portion 2b axially extends from the inner raceway surface 2a. A serration (or spline) 2c is formed on the wheel hub inner circumference. Hub bolts 5 are arranged on the wheel mounting flange 4 equidistantly along the periphery of the wheel mounting flange 4.

The wheel hub 2 is made of medium/high carbon steel including carbon of 0.40˜0.80% by weight such as S53C. It is hardened by high frequency induction quenching so that a region from an inner side base 7 of the wheel mounting flange 4, forming a seal-land portion to which an outer side seal 11 slidingly contacts, to the cylindrical portion 2b is hardened to have a surface hardness of 58˜64 HRC. The inner ring is formed, on its outer circumference, with the other (inner side) inner raceway surface 3a. The inner ring is press-fit onto the cylindrical portion 2b of the wheel hub 2 via a predetermined interference. The inner ring is axially immovably secured by a caulked portion 6. The caulked portion 6 is formed by plastically deforming the end of the cylindrical portion 2b radially outward. Since the end face of the caulked portion 6 is formed as a flat surface, it is possible to reduce the bearing pressure applied to the caulked portion by an axial force. Thus, this reduces a plastic deformation and wear of the caulked portion 6. The inner ring 3 and balls 8 are made of high carbon chrome steel such as SUJ2. They are hardened to their core by dip quenching to have a surface hardness of 58˜64 HRC.

The outer member 10 is integrally formed, on its outer circumference, with a body mounting flange 10b to be mounted on a body of a vehicle (not shown). The outer member inner circumference includes double row outer raceway surfaces 10a, 10a opposite to the inner raceway surfaces 2a, 3a of the inner member 1. The outer member 10 is made of medium/high carbon steel including carbon of 0.40˜0.80% by weight such as S53C. At least the double row outer raceway surfaces 10a, 10a are hardened by high frequency induction quenching to have a surface hardness of 58˜64 HRC. Double row balls 8, 8 are contained between the outer and inner raceway surfaces 10a, 2a and 10a, 3a of the outer member 10 and the inner member 1. The balls 8, 8 are rollably held by cages 9, 9. Seals 11, 12 are mounted within annular openings formed between the outer member 10 and the inner member 1. The seals 8, 9 prevent leakage of grease contained in the bearing and the entry of rainwater and dust into the bearing from outside.

Although the wheel bearing apparatus is shown formed with a double row angular contact ball bearing using balls as rolling elements 8, the present disclosure is not limited to such a bearing. It may be applied to a double row tapered roller bearing using tapered rollers as rolling elements 8. In addition, although the structure shown here is a so-called third generation type bearing structure, the wheel bearing apparatus of the present disclosure is not limited to such a structure. It may be applied to bearing structures of a so-called first or second generation type where a pair of inner rings are press-fit onto a cylindrical portion of a wheel hub.

The constant velocity universal joint 13 includes an outer joint member 14, a joint inner ring, a cage and torque transmitting balls (not shown). The outer joint member 14 is made of medium/high carbon steel including carbon of 0.40˜0.80% by weight such as S53C. The outer joint member 14 includes an integrally formed cup shaped mouth portion (not shown), a shoulder portion 15 and a stem portion 16. The shoulder portion 15 forms a bottom of the mouth portion. The stem portion 16 axially extends from the shoulder portion 15. The stem portion 16 is formed, on its outer circumference, with a serration (or spline) 16a to engage a serration 2c of the wheel hub 2. The end of the stem portion 16 includes an outer thread (male thread) 16b. The stem portion 16 of the outer joint member 14 is inserted into the wheel hub 2 until the shoulder portion 15 abuts against the caulked portion 6, via a cap 17 later described. Finally a securing nut 18 is fastened onto the outer thread 16b at a predetermined fastening torque. Thus, the wheel hub 2 and the outer joint member 14 are axially separably connected with each other.

The cap 17 is mounted on the caulked portion 6. The cap 17 is secured by being sandwiched between the caulked portion 6 and the shoulder portion 15 of the outer joint member 14. The cap 17 has a metal core 20 and a molded portion 21 integrally adhered to the metal core 20 by injection molding. The metal core 20 is press-formed from a corrosion resistant steel sheet, such as preserved cold rolled steel sheet (JIS SPCC etc.) or austenitic-stainless steel sheet (JIS SUS 304 etc.). The metal core 20 has a generally open ended ring shape with a substantially L-shaped cross-section. As shown in the enlarged view of FIG. 2, the metal core 20 includes a disc-shaped portion 20a, a cylindrical portion 20b and an anchoring portion 20c. The cylindrical portion 20b axially extends from a radially outermost portion of the disc-shaped portion 20a. The anchoring portion 20c projects radially inward from the cylindrical portion 20b. The inner diameter of the anchoring portion 20c of the metal core 20 is set slightly smaller than the outer diameter of the caulked portion 6. Thus, the cap 17 can be easily snap-fit onto the caulked portion 6 by elastically enlarging the diameter of the anchoring portion 20c. Accordingly, it is possible to improve the workability of assembly by mounting the cap 17 on the caulked portion 6 with a one-touch manner.

The molded portion 21 is formed from fiber reinforced thermoplastic synthetic resin such as PA (polyamide) 66 etc. containing fibrous reinforcement such as GF (glass fiber) of 10˜40 weight %. The molded portion 21 is adhered to the inner-side surface of the disc-shaped portion 20a of the metal core 20 by injection molding. If the contents of GF are less than 10 weight %, it cannot exhibit sufficient reinforcing effect. On the other hand, if the contents of GF exceeds 40 weight %, it causes anisotropy of the fibers in a molded article and increases the density of the GF and thus detracts the dimensional stability and toughness of the molded portion 21. Accordingly, it is believed that the molded portion 21 would be cracked or broken by elastic deformation of the metal core 20 when the cap 17 is mounted on the caulked portion 6. The fibrous reinforcement is not limited to GF and other materials such as CF (carbon fiber), aramid fiber, boron fiber, etc. can be used as the fibrous reinforcement.

The molded portion 21 can be formed, other than PA 66, from thermoplastic resin so-called engineering plastic, such as PPA (polyphthal amide), PBT (polybutylene terephthalate) etc., thermoplastic resin so-called as super engineering plastic such as polyphenylene sulfide (PPS), polyetheretherketon (PEEK), polyamideimide (PAI) etc., or thermosetting resin such as phenol resin (PF), epoxy resin (EP), polyimide resin (PI) etc. Furthermore, in order to reduce the environmental load, the molded portion 21 can be formed from biodegradable synthetic resin such as polylactic acid, polycaprolactone, polyglycol acid, denaturation polyvinyl alcohol, casein etc.

The cap 17 is structured so that the metal core 20 of the cap 17 abuts against the end face of the caulked portion 6. The molded portion 21 abuts against the shoulder portion 15 of the outer joint member 14. An infinite number of micro indentations are formed on both surfaces of the metal core 20 and the molded portion 21. In particular, as shown in FIG. 3 the surface of the metal core 20, adapted to abut against the caulked portion 6, is formed with indentations by shot blasting. It is treated as having a surface roughness of Ra 1.6 or less, preferably Ra 0.32 or less. Herein, “Ra” denotes one of the roughness shape parameters of JIS (JIS B0601-1994) and means arithmetic roughness average of absolute value deviations from the average line.

An infinite number of micro indentations are also formed on the surface of the molded portion 21 that abuts against the shoulder portion 15 of the outer joint member 14. These indentations are formed by controlling a surface of the mold on molding and the surface roughness is set at Ra 1.6 or less, preferably Ra 0.32 or less. In addition, the surface roughness of the surfaces of the end face of the caulked portion 6 and the shoulder portion 15 of the outer joint member 14 is set on Ra 1.6 or less, preferably Ra 0.32 or less. The provision of such a cap 17 makes it possible to suppress wear of the cap 17 and thus improve its durability. Furthermore, it is possible to reduce the coefficient of friction of each abutting surface. Thus, this suppresses wear of the caulked portion 6, and prevents the generation of the stick-slip noise while reducing sudden slip caused between the caulked portion 6 and the shoulder portion 15 of the outer joint member 14.

The cap 17 with the molded portion 21 is shown abutted against the shoulder portion 15 of the outer joint member 14. The side surface of the metal core 20, not having the molded portion 21, is abutted against the end face of the caulked portion 6. However, the present disclosure is not limited to such a cap 17. It can be applied to a cap where the outer-side surface of the disc-shaped portion 20a of the metal core is formed with the molded portion 21 and abuts against the shoulder portion 15 of the outer joint member 14. The molded portion 21 abuts against the end face of the caulked portion 6.

A modification of the cap 17 of FIG. 2 is shown in FIG. 4. This cap 22 includes a metal core 23 and a molded portion 24 integrally adhered to the metal core 23 by injection molding. The metal core 23 is press-formed from a corrosion resistant steel sheet such as. preserved cold rolled steel sheet or austenitic-stainless steel sheet. The metal core 23 has a ring shape with a substantially L-shaped cross-section. The metal core 23 includes a disc-shaped portion 23a, a cylindrical portion 23b and a plurality of claws 23c. The cylindrical portion 23 b axially extends from a radially outermost portion of the disc-shaped portion 23a. The plurality of claws (anchoring portion) 23c project radially inward from the cylindrical portion 23b. The claws 23c are arranged equidistantly along the periphery of the metal core 23. The inner diameter formed by tip ends of the claws 23c of the metal core 23 is set slightly smaller than the outer diameter of the caulked portion. Thus, the cap 22 can be easily snap-fit onto the caulked portion in a one-touch manner by elastically enlarging the diameter of the claws 23c.

The molded portion 24 is formed of fiber reinforced thermoplastic synthetic resin such as PA 66 etc. containing fibrous reinforcement such as CF of 5˜40 weight %. The molded portion 24 is adhered to the disc-shaped portion 23a of the metal core 23 by injection molding. In this case, if the contents of CF is less than 5 weight %, it cannot exhibit sufficient reinforcing effect. On the other hand, if the contents of CF exceeds 40 weight %, it causes reduction of toughness of the molded portion 24. Accordingly it is believed that the molded portion 24 would be cracked or broken when the cap 22 is mounted on the caulked portion.

Lubricant such as grease etc. is applied between the caulked portion 6 and the shoulder portion 15 of the outer joint member 14. A number of through apertures 25 are formed on the disc-shaped portion 23a of the metal core 23. The through apertures 25 hold the lubricant applied to the abutting surfaces. Thus, this further reduces the coefficients of friction of the abutting surfaces and further effectively prevents the generation of the stick-slip noise.

FIG. 5 shows another modification of the cap 17 of FIG. 2. The cap 26 includes a metal core 27. The molded portion 28 is integrally adhered to the metal core 27 by injection molding. The metal core 27 is press-formed from a corrosion resistant steel sheet, such as preserved cold rolled steel sheet or austenitic-stainless steel sheet. The metal core 27 has a generally open ended ring shape with a substantially L-shaped cross-section. This metal core 27 has a disc-shaped portion 27a, a cylindrical portion 20b and an anchoring portion 20c. The cylindrical portion 20b axially extends from a radially outermost portion of the disc-shaped portion 20a. The anchoring portion 20c projects radially inward from the cylindrical portion 20b.

Similar to the previously described embodiments, the metal core 27 of this embodiment abuts against the caulked portion 29 and the molded portion 28 abuts against the shoulder portion 15. The surfaces of the metal core 27 and the mold portion 28 are formed with an infinite number of micro indentations. Furthermore, the end face of the caulked portion 29 is formed with an annular groove 29a. The disc-shaped portion 27a of the metal core 27 is formed with an annular projection 30. The annular projection axially projects from the disk shaped portion to engage with the annular groove 29a. This makes it possible to easily achieve a radial positioning of the cap 26 relative to the caulked portion 29. This prevents slipping-off of the cap 26 during transportation or assembly of the wheel bearing. Also, it surely prevents a tilted mount of the cap 26 during assembly and thus improves the reliability of assembly.

The present disclosure can be applied to a wheel bearing apparatus of the first through third generations including an inner member with a wheel hub, an inner ring and a constant velocity universal joint. The inner member and the outer joint member of the constant velocity universal joint are separably fastened in an abutted condition.

The present disclosure has been described with reference to the preferred embodiments. Obviously, modifications and alternations will occur to those of ordinary skill in the art upon reading and understanding the preceding detailed description. It is intended that the present disclosure be construed as including all such alternations and modifications insofar as they come within the scope of the appended claims or their equivalents thereof.

What is claimed is:

1. A vehicle wheel bearing apparatus comprising:
an outer member integrally formed on its inner circumference with double row outer raceway surfaces;
an inner member including a wheel hub and at least one inner ring, the inner member including double row inner raceway surfaces arranged opposite to the double row outer raceway surfaces, the wheel hub includes a wheel mounting flange on its one end and an axially extending cylindrical portion on its other end, the inner ring is press fit onto the cylindrical portion of the wheel hub;
double row rolling elements are rollably contained between the double row inner and outer raceway surfaces of the inner member and the outer member via cages;
seals are mounted in annular space openings formed between the outer member and the inner member;
the inner ring is axially immovably secured relative to the wheel hub by a caulked portion, the caulked portion is formed by plastically deforming an end of the cylindrical portion radially outward;
a constant velocity universal joint is connected to the wheel hub;
an outer joint member of the constant velocity universal joint includes a cup-shaped mouth portion, a shoulder portion forming a bottom of the mouth portion, and a stem portion fit into the wheel hub via serrations in a torque transmittable manner;
the wheel hub and the outer joint member are axially detachably connected, the shoulder portion abuts against the caulked portion;
an end face of the caulked portion is formed with a flat surface, a cap is mounted on the caulked portion; and
the cap includes a metal core press-formed from a corrosion resistant steel sheet, the cap has a generally ring shape with a substantially L-shaped cross-section and a molded portion, the molded portion is formed from synthetic resin and has an infinite number of micro indentations on its surface, the cap abuts against the end face of the caulked portion and the shoulder portion of the outer joint member.

2. The vehicle wheel bearing apparatus of claim 1, wherein the molded portion has a surface roughness of Ra 1.6 or less.

3. The vehicle wheel bearing apparatus of claim 1, wherein the surface of the metal core is formed with an infinite number of micro indentations.

4. The vehicle wheel bearing apparatus of claim 3, wherein the indentations of the metal core are formed by shot blasting and have a surface roughness of Ra 1.6 or less.

5. The vehicle wheel bearing apparatus of claim 1, wherein the metal core comprises a disc-shaped portion, a cylindrical portion and an anchoring portion, the cylindrical portion axially extends from a radially outermost portion of the disc-shaped portion, the anchoring portion projects radially inward from the cylindrical portion, the molded portion is adhered to the disc-shaped portion, and the inner diameter of the anchoring portion of the metal core is set slightly smaller than an outer diameter of the caulked portion.

6. The vehicle wheel bearing apparatus of claim 5, wherein the metal core is formed as an open ended ring shape.

7. The vehicle wheel bearing apparatus of claim 5, wherein a plurality of the anchoring portions are formed equidistantly along the periphery of the metal core.

8. The vehicle wheel bearing apparatus of claim 1, wherein a lubricant is applied between the caulked portion and the shoulder portion of the outer joint member.

9. The vehicle wheel bearing apparatus of claim 1, wherein a number of through apertures are formed on the disc-shaped portion of the metal core.

10. The vehicle wheel bearing apparatus of claim 1, wherein the end face of the caulked portion and the shoulder portion of the outer joint member have a surface roughness of Ra 1.6 or less.

11. The vehicle wheel bearing apparatus of claim 1, wherein the end face of the caulked portion is formed with an annular groove, and a disc-shaped portion of the metal core is formed with an annular projection that axially projects from the disk shaped portion to engage the annular groove.

12. The vehicle wheel bearing apparatus of claim 1, wherein the molded portion is formed from fiber reinforced thermoplastic synthetic resin.

13. The vehicle wheel bearing apparatus of claim 1, wherein the molded portion is formed of biodegradable synthetic resin.
